(19) United States
(12) Patent Application Publication
(10) Pub. No.: US 2011/0105066 A1
(43) Pub. Date: May 5, 2011

(54) FREQUENCY CONVERTER CIRCUIT AND RECEIVING APPARATUS

(75) Inventor: Toshio Orii, Chino (JP)

(73) Assignee: SEIKO EPSON CORPORATION, Shinjuku-ku (JP)

(21) Appl. No.: 12/939,130

(22) Filed: Nov. 3, 2010

(30) Foreign Application Priority Data
Nov. 5, 2009 (JP) 2009-253733

(51) Int. Cl. H04W 4/00

(52) U.S. Cl. 455/131

(57) ABSTRACT

A frequency converter circuit which multiplies a received signal which is a radio frequency signal by a locally-generated signal and extracts a signal including a frequency corresponding to a difference between the harmonic of the locally-generated signal and the frequency of the radio frequency signal, includes: a mixer section that multiplies the received signal by the locally-generated signal; a timing signal generation section that generates a timing signal synchronized with the locally-generated signal; a sample-and-hold section that samples and holds an output signal of the mixer section according to the timing signal; and a filter section that extracts, from an output signal of the sample-and-hold section, a signal component including the frequency corresponding to the difference between the harmonic of the locally-generated signal and the frequency of the radio frequency signal.

### BACKGROUND

1. Technical Field

The present invention relates to a frequency converter circuit and a receiving apparatus provided with the frequency converter circuit.

2. Related Art

A wireless communication device uses a mixer which converts (down-converts) a received signal into an intermediate frequency signal (an IF signal) by multiplying the received signal by a locally-generated signal (a local signal) generated by a local oscillator provided in the device. When, although a locally-generated signal having a frequency close to the frequency of a received signal is required, it is difficult to form a local oscillator with a required radio frequency because, for example, the received signal is a radio frequency signal (an RF signal), a subharmonic mixer has been known (see, for example, JP-A-2009-38681) which obtains a signal having a frequency corresponding to a difference between the frequency of the received signal and the N-th harmonic (the N-times wave) of the locally-generated signal by using a local oscillator with an oscillation frequency of 1/N of the required frequency.

### SUMMARY

Since an IF signal obtained by a subharmonic mixer uses the harmonic (the N-th harmonic) of a locally-generated signal, the greater the order N becomes, the smaller the magnitude of a signal which can be extracted becomes, resulting in a reduction in conversion efficiency. An advantage of some aspects of the invention is to enhance conversion efficiency in a subharmonic mixer using a high-order harmonic component of a locally-generated signal.

According to a first aspect of the invention, there is provided a frequency converter circuit which multiplies a received signal which is a radio frequency signal by a locally-generated signal and extracts a signal having a frequency corresponding to a difference between the harmonic of the locally-generated signal and the frequency of the radio frequency signal. The frequency converter circuit including: a mixer section multiplying the received signal by the locally-generated signal; a timing signal generation section generating a timing signal synchronized with the locally-generated signal; a sample-and-hold section sampling and holding an output signal of the mixer section according to the timing signal; and a filter section extracting, from an output signal of the sample-and-hold section, a signal component having the frequency corresponding to the difference between the harmonic of the locally-generated signal and the frequency of the radio frequency signal.

According to the first aspect of the invention, in the frequency converter circuit which multiplies a received signal which is a radio frequency signal by a locally-generated signal and extracts a signal having a frequency corresponding to a difference between the frequency of the radio frequency signal and the harmonic of the locally-generated signal, the output signal of the mixer section multiplying a received signal which is a radio frequency signal by a locally-generated signal is sampled and held by the sample-and-hold section according to the timing signal synchronized with the locally-generated signal. The filter section extracts, from the output signal of the sample-and-hold section, a signal having a frequency corresponding to a difference between the frequency of the radio frequency signal and the harmonic of the locally-generated signal. By sampling the output signal of the mixer section when the output signal is large and holding the value thereof, the signal extracted by the filter section becomes large, whereby the conversion efficiency of the frequency converter circuit is enhanced.

According to a second aspect of the invention, the frequency converter circuit of the first aspect of the invention may be configured as a frequency converter circuit in which a frequency band to be extracted by the filter section is defined so that the filter section performs the extraction by setting the frequency of the harmonic at a frequency which is N (N≧3) times the frequency of the locally-generated signal.

According to the second aspect of the invention, in the frequency converter circuit, a signal having a frequency corresponding to a difference between the harmonic (the N-th harmonic) whose frequency is N (N≧3) times the frequency of the locally-generated signal and the frequency of the radio frequency signal which is a received signal is extracted.

According to a third aspect of the invention, the frequency converter circuit of the first or second aspect of the invention may be configured as a frequency converter circuit further including a locally-generated signal generation section generating the locally-generated signal as a square wave, wherein, based on the locally-generated signal generated as the square wave and a delay signal obtained by delaying the locally-generated signal, the timing signal generation section generates a pulse signal synchronized with an edge of the locally-generated signal as the timing signal.

According to the third aspect of the invention, based on the locally-generated signal generated as the square wave and a delay signal obtained by delaying the locally-generated signal, a pulse signal synchronized with an edge of the locally-generated signal is generated as the timing signal.

According to a fourth aspect of the invention, the frequency converter circuit of any one of the first to third aspects of the invention may be configured as a frequency converter circuit in which the radio frequency signal has a single frequency which is previously defined, the frequency converter circuit configured as a frequency converter circuit dedicated to the single frequency.

According to a fifth aspect of the invention, the frequency converter circuit of any one of the first to fourth aspects of the invention may be configured as a frequency converter circuit in which the radio frequency signal is a satellite signal transmitted by a positioning satellite.

According to a sixth aspect of the invention, a receiving apparatus including the frequency converter circuit of the fifth aspect of the invention may be configured.

### BRIEF DESCRIPTION OF THE DRAWINGS

The invention will be described with reference to the accompanying drawings, wherein like numbers reference like elements.

FIG. 1 is a block configuration diagram of a GPS receiving apparatus.

FIG. 2 is a block configuration diagram of a frequency conversion section.

FIG. 3 is a circuit diagram of a mixer.

FIG. 4 is a circuit diagram of a locally-generated signal generation section.

FIG. 5 is a circuit diagram of a timing adjustment circuit and a sample-and-hold circuit.

FIG. 6 is an explanatory diagram of timing signal generation principles.

FIG. 7 is a signal waveform diagram in each part of the frequency conversion section.

### DESCRIPTION OF EXEMPLARY EMBODIMENTS

Hereinafter, an embodiment of the invention will be described with reference to the drawings. A case in which the invention is applied to a GPS receiving apparatus receiving a GPS signal transmitted from a GPS (global positioning system) satellite which is a type of positioning satellite will be described. However, an embodiment to which the invention can be applied is not limited to the embodiment described below.

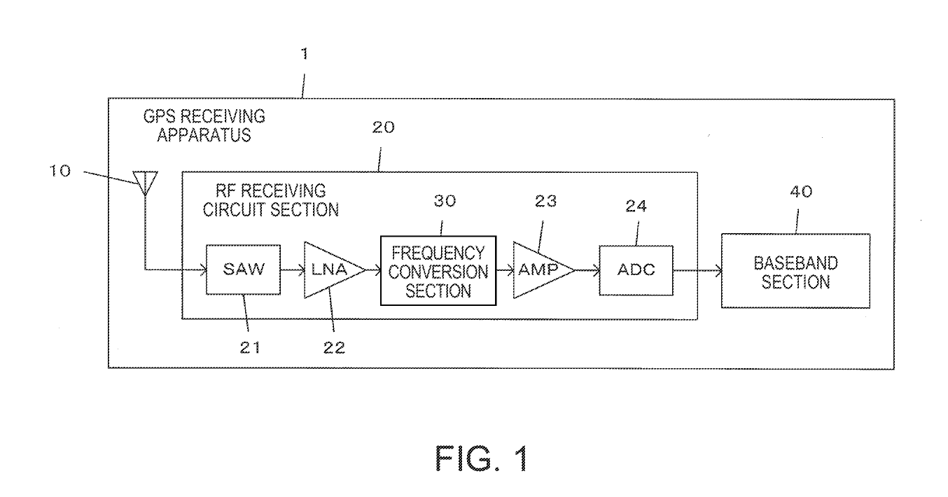

FIG. 1 is a block configuration diagram of a GPS receiving apparatus 1 in this embodiment. The GPS receiving apparatus 1 includes a GPS antenna 10, an RF (radio frequency) receiving circuit section 20, and a baseband section 40.

The GPS antenna 10 receives an RF signal including a GPS satellite signal transmitted from a GPS satellite which is a type of positioning satellite. The GPS satellite signal is a 1.57542 GHz communication signal directly modulated by a spectrum spread system using a PRN (pseudo random noise) code which is a type of spread code that differs from GPS satellite to GPS satellite. The PRN code is a pseudo random noise code with a repetition period of 1 ms and with one frame having a code length of 1023 chips.

The RF receiving circuit section 20 has a SAW (surface acoustic wave) filter 21, an LNA (low noise amplifier) 22, a frequency conversion section 30, an amplification section 23, and an ADC (analog-to-digital converter) 24.

The SAW filter 21 is a bandpass filter, and, for the RF signal received by the GPS antenna 10, allows a signal in a predetermined band to pass therethrough and blocks a frequency component which lies outside this band. The LNA 21 is a low-noise amplifier, and amplifies the RF signal output from the SAW filter 21.

The frequency conversion section 30 converts a frequency by a subharmonic system by which the RF signal output from the LNA 21 is converted into an intermediate frequency signal (an IF signal) having a frequency |F_{RF}−F_{Lo}×N| by multiplying the RF signal by a locally-generated signal Lo having a frequency F_{Lo} which is nearly 1/N (N≧3) of the frequency F_{RF} of the RF signal.

The amplification section 23 amplifies the IF signal output from the frequency conversion section 30. The ADC 24 converts the IF signal, which is an analog signal output from the amplification section 23, into a digital signal.

The baseband section 40 performs correlation processing on the IF signal output from the RF receiving circuit section 20 and thereby capturing and extracting the GPS satellite signal and extracting a navigation massage and time information by decoding the data, and performs calculation of a pseudo distance and a positioning operation.

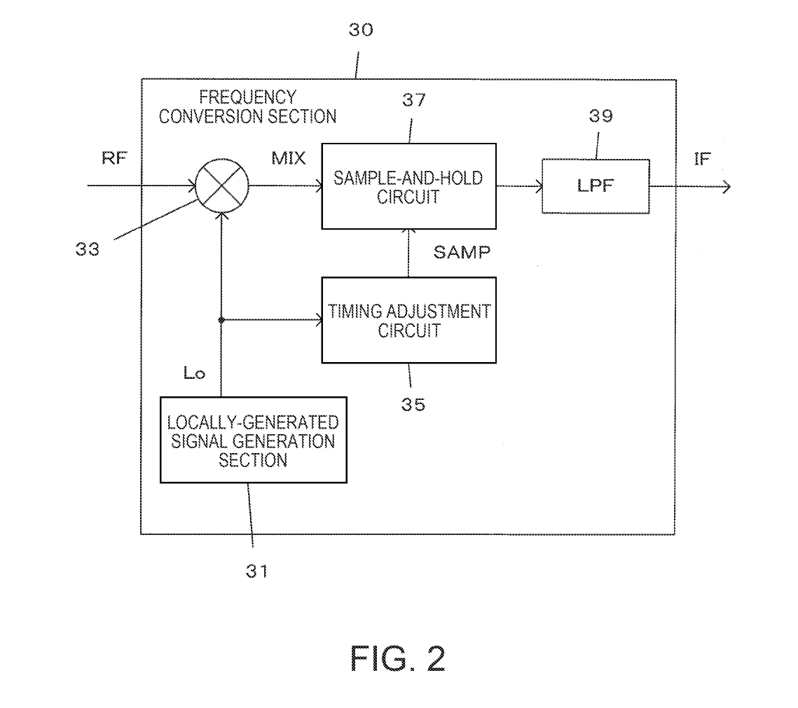

FIG. 2 is a block configuration diagram of the frequency conversion section 30. The frequency conversion section 30 includes a locally-generated signal generation section 31, a mixer 33, a timing adjustment circuit 35, a sample-and-hold circuit 37, and an LPF 39.

The locally-generated signal generation section 31 has an oscillator such as a VCO (voltage controlled oscillator), and generates a locally-generated signal (a local signal) Lo having a frequency F_{Lo} which is nearly 1/N of the frequency F_{RF} of the received RF signal.

The mixer 33 is realized as a gilbert cell or double balanced mixer, and multiplies (combines) the RF signal input from the LNA 22 by (with) a locally-generated signal Lo output from the locally-generated signal generation section 31. Since the mixer 33 is used as a subharmonic mixer, a signal MIX output from the mixer 33 includes a signal having a frequency |F_{RF}−F_{Lo}×N| corresponding to a difference between the frequency of the RF signal and the N-th harmonic of the locally-generated signal Lo.

The sample-and-hold circuit 37 samples and holds the signal MIX output from the mixer 33 according to a timing signal SAMP output from the timing adjustment circuit 35. The timing adjustment circuit 35 generates, as a timing signal SAMP, a pulse signal synchronized with the locally-generated signal Lo output from the locally-generated signal generation section 31.

For a signal HOLD output from the sample-and-hold circuit 37, the LPF 39 allows a signal in a low frequency band to pass therethrough, the low frequency band including a frequency |F_{RF}−F_{Lo}×N| corresponding to a difference between the frequency of the RF signal and the N-th harmonic of the locally-generated signal Lo, and blocks a frequency component which lies outside this band. From the frequency conversion section 30, a signal having a frequency |F_{RF}−F_{Lo}×N| is output as an IF signal.

In this embodiment, the harmonic of the locally-generated signal Lo used in the frequency conversion section 30 is preferably the third or higher harmonic (N≧3), and, more preferably, the tenth or more harmonic (N≧10). The reason is as follows. When the harmonic of the locally-generated signal Lo is the tenth or more harmonic, the oscillation frequency of the oscillator (the local oscillator) of the locally-generated signal generation section 31 becomes lower, and this reduces power consumption.

This embodiment is a GPS receiving apparatus, and the received frequency is one type of frequency (1.57542 GHz). The oscillation frequency required for the local oscillator is also one type of frequency. In a receiving apparatus using a subharmonic mixer, the precision of the local oscillator is important because the harmonic of the locally-generated signal Lo is used. In a receiving apparatus designed on the assumption that a plurality of types of frequency are received, a plurality of high-precision local oscillators provided for the received frequencies are necessary. Since this embodiment only needs one type of local oscillator which is previously determined, the receiving apparatus can be configured easily as compared to the receiving apparatus which receives a plurality of types of frequency.

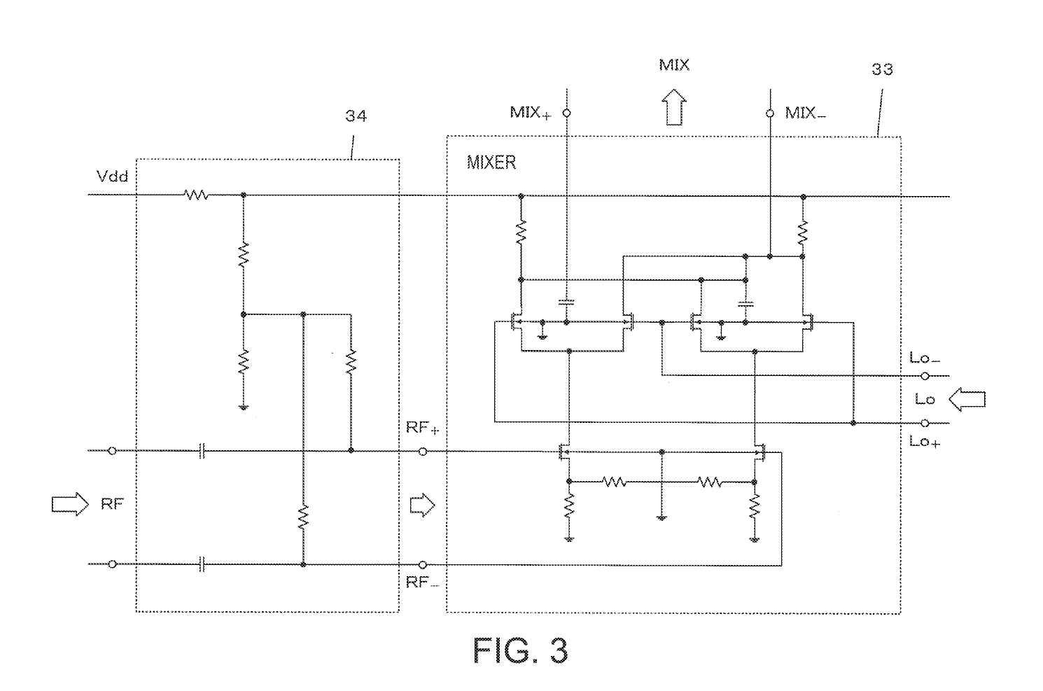

FIGS. 3 to 5 show examples of a circuit when the frequency conversion section 30 is configured by using a gilbert cell mixer as the mixer 33. FIG. 3 is a circuit diagram of the mixer 33. The mixer 33 is a gilbert cell mixer formed of a plurality of MOS transistors. To the mixer 33, the RF signal is input in the differential form of signals RF₊ and RF₋, and the locally-generated signal Lo is input in the differential form of signals Lo₊ and Lo₋. From the mixer 33, a signal MIX obtained by multiplying (combining) the input RF signal by (with) the input locally-generated signal Lo is output in the differential form of signals MIX₊ and MIX₋. At the input stage of the mixer 33, a converter circuit 34 which converts the RF signal output from the LNA 22 into the input signals RF₊ and RF₋ in the differential form is provided. In FIG. 2, the converter circuit 34 is not shown.

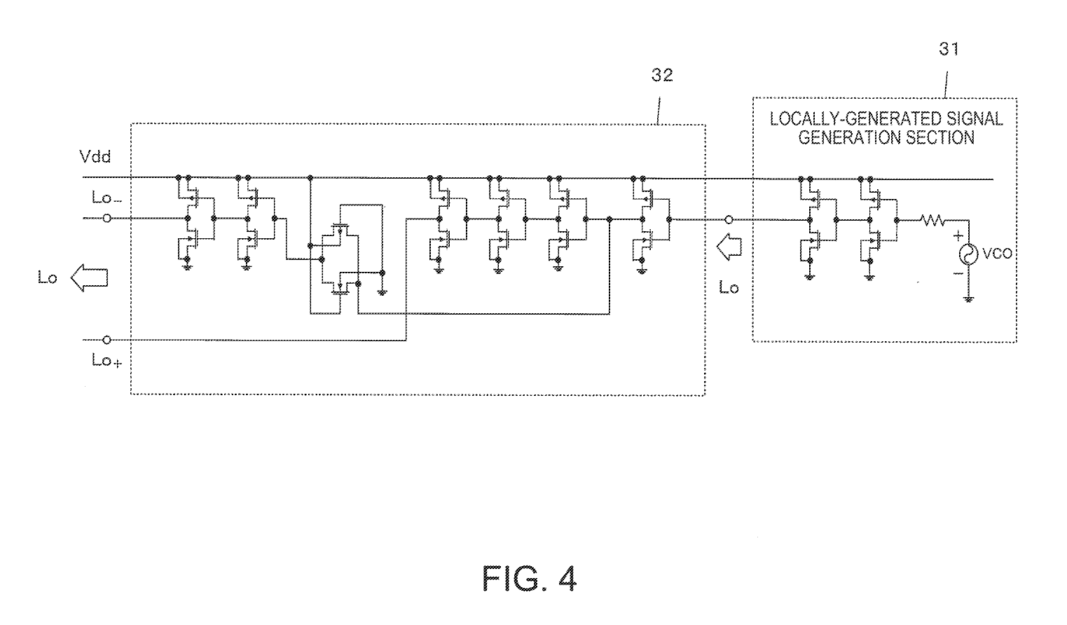

FIG. 4 is a circuit diagram of the locally-generated signal generation section 31. The locally-generated signal generation section 31 has a VCO which generates a locally-generated signal Lo having a predetermined frequency F_{Lo}. The sinusoidal oscillation signal Lo generated by the VCO is converted into a square wave by a switching circuit formed of a MOS transistor.

At an output stage of the locally-generated signal generation section 31, a converter circuit 32 which converts the locally-generated signal Lo generated by the locally-generated signal generation section 31 into signals Lo₊ and Lo₋ in the differential form is provided. The locally-generated signal Lo generated by the locally-generated signal generation section 31 is converted by the converter circuit 32 into differential signals Lo₊ and Lo₋ and input to the mixer 33. In FIG. 2, the converter circuit 32 is not shown.

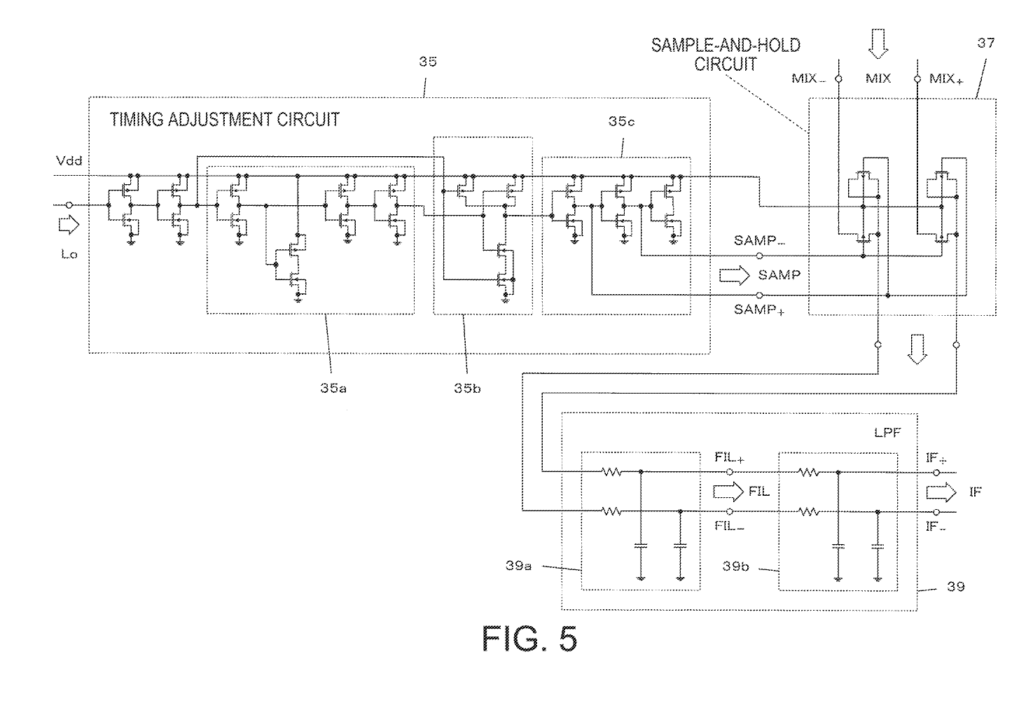

FIG. 5 is a circuit diagram of the timing adjustment circuit 35 and the sample-and-hold circuit 37. To the sample-and-hold circuit 37, the output signals MIX₊ and MIX₋ in the differential form are input from the mixer 33, and the timing signals SAMP₊ and SAMP₋ in the differential form are input from the timing adjustment circuit 35. From the sample-and-hold circuit 37, the signals which are input mixer output signals MIX₊ and MIX₋ sampled and held according to the timing signals SAMP₊ and SAMP₋ are output. The output signal of the sample-and-hold circuit 37 passes through the LPF 39 in the following stage and is then output as an IF signal.

The LPF 39 is formed of an LPF 39a and an LPF 39b provided in two stages. The front-stage LPF 39a has the pass characteristic that allows the frequency component F_{Lo} of the locally-generated signal Lo to pass therethrough and blocks the frequency component F_{RF} of the RF signal. The back-stage LPF 39b has the pass characteristic that allows the frequency component F_{IF} of the IF signal to pass therethrough and blocks the frequency component F_{Lo} of the locally-generated signal Lo.

The timing adjustment circuit 35 has a delay circuit 35a, a pulse generation circuit 35b, and a differential signal generation circuit 35c. The delay circuit 35a delays the input locally-generated signal Lo by a predetermine time Δt. The pulse generation circuit 35b generates a pulse signal synchronized with a rising edge of the locally-generated signal Lo by calculating a differential signal between the input locally-generated signal Lo and the delay signal Lo1 delayed by the delay circuit 35a. The differential signal generation circuit 35c converts the pulse signal generated by the pulse generation circuit 35b into the signals SAMP₊ and SAMP₋ in the differential form.

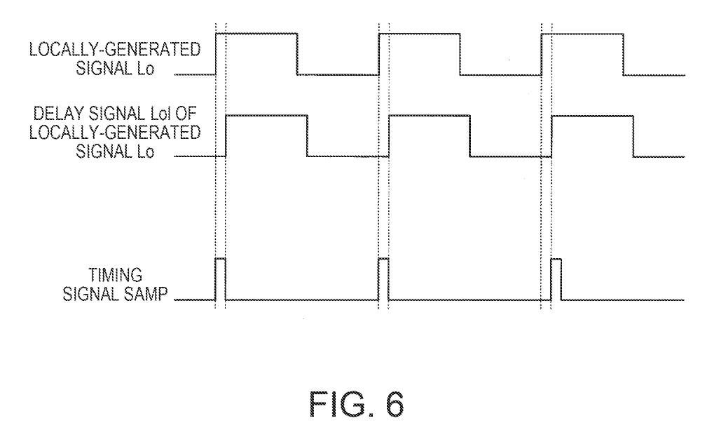

FIG. 6 is a diagram explaining the generation principles of the timing signal SAMP in the timing adjustment circuit 35. In the drawing, the lateral direction represents time t, and the voltage waveforms of the input locally-generated signal Lo, the delay signal Lo1 output from the delay circuit 35a, and the pulse signal output from the pulse generation circuit 35b are shown from top to bottom.

The delay circuit 35a generates the delay signal Lo1 obtained by delaying the input locally-generated signal Lo by a predetermined time Δt. Next, the pulse generation circuit 35b generates a pulse signal synchronized with the rising timing (edge) of the locally-generated signal Lo by calculating a difference between the input locally-generated signal Lo and the delay signal Lo1. This pulse signal becomes the timing signal SAMP.

The generated timing signal SAMP is converted into the signals SAMP₊ and SAMP₋ in the differential form by the differential signal generation circuit 35c and input to the sample-and-hold circuit 37.

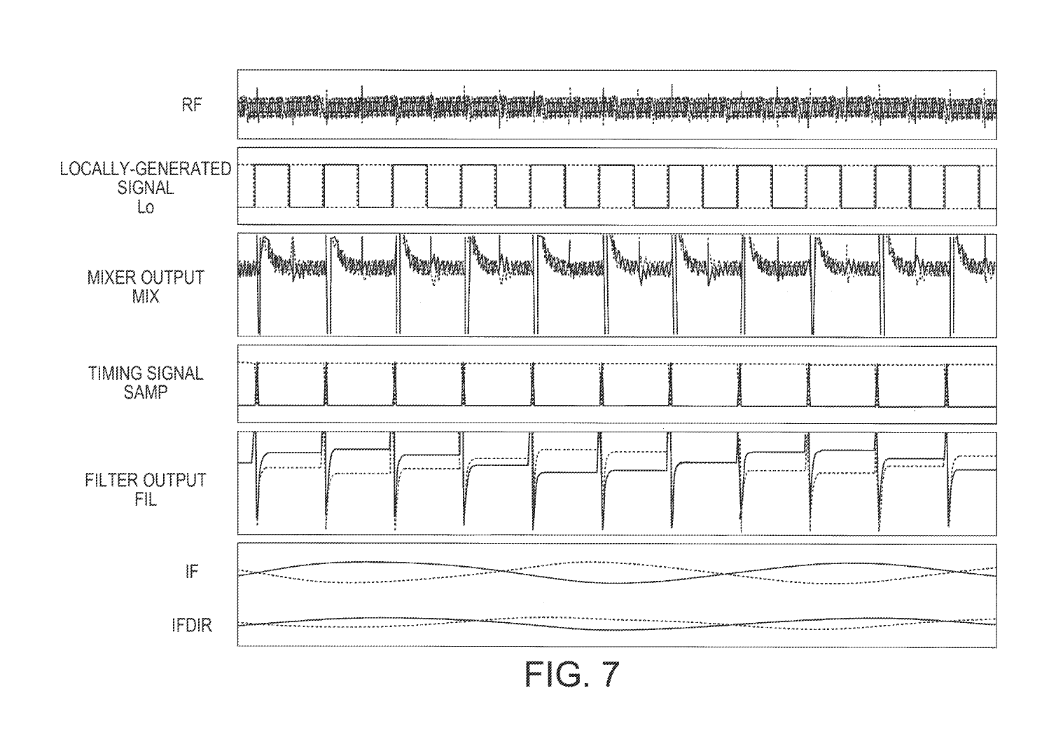

FIG. 7 is a diagram for explaining the operation when the frequency conversion section 30 has the circuit configuration shown in FIGS. 3 to 5. In the drawing, the lateral direction represents time t, and the voltage waveforms of the RF signal input to the frequency conversion section 30, the locally-generated signal Lo (Lo₊, Lo₋) input to the mixer 33, the timing signal SAMP (SAMP₊, SAMP₋) input to the sample-and-hold circuit 37, the output signal MIX (MIX₊, MIX₋) from the mixer 33, the output signal FIL (FIL₊, FIL₋) from the LPF 39a, and the output signal (that is, the IF signals IF₊ and IF₋ output from the frequency conversion section 30) from the LPF 39 are shown from top to bottom. For comparison with the existing example, for the output signal MIX of the mixer 33, a signal IFDIR (IFDIR₊, IFDIR₋) which is passed through the LPF 39 without passing through the sample-and-hold circuit 37 is shown along with the IF signal. Each waveform shows differential signals by a solid line and a broken line.

The output signal MIX of the mixer 33, the output signal MIX generated by multiplying (combining) the RF signal which is a radio frequency signal by (with) the locally-generated signal Lo which is a low frequency signal relative to the RF signal, has a sawtooth waveform whose amplitude reaches its greatest amplitude with the rising timing of the locally-generated signal Lo, the waveform which is restored to a predetermined voltage while decreasing with time. The timing signal SAMP generated by the timing adjustment circuit 35 has a pulse waveform synchronized with the rising edge of the locally-generated signal Lo.

The output signal MIX of the mixer 33 is sampled and held with timing according to the timing signal SAMP by the sample-and-hold circuit 37, passes through the LPF 39a, whereby the radio frequency component is removed therefrom, and is output as a signal FIL. The signal FIL output from the LPF 39a has a waveform in which the amplitude value of the output signal MIX of the mixer 33 is sampled when the output signal MIX of the mixer 33 reaches its greatest amplitude and the sampled amplitude value is held until a next time of sampling.

The signal FIL output from the LPF 39a passes through the back-stage LPF 39b, whereby the radio frequency component is removed therefrom, and is output as an IF signal IF having a lower frequency. A voltage difference between the IF signals IF₊ and IF₋ corresponds to the amplitude of the IF signal IF.

A comparison of the IF signal IF output from the frequency conversion section 30 of this embodiment and the IF signal IFDIR which has not passed through the sample-and-hold circuit 37 reveals that the amplitude of the IF signal IF is greater than that of the IF signal IFDIR. The reason is as follows. The output signal MIX of the mixer 33 is sampled by the sample-and-hold circuit 37 with timing with which the output signal MIX of the mixer 33 reaches its greatest amplitude, and the sampled amplitude value is held until a next time of sampling, whereby a reduction in the IF signal associated with a reduction in the signal MIX which occurs between the times of sampling is alleviated. In this way, the frequency conversion section 30 of a subharmonic system, the frequency conversion section 30 whose conversion efficiency is enhanced as compared to the existing example, is realized.

### MODIFIED EXAMPLES

The invention is not limited in any way by the embodiment thereof described above, and changes can be made therein without departing from the spirit of the invention.

### (A) Timing Signal SAMP

The timing signal SAMP input to the sample-and-hold circuit 37 is assumed to be a pulse signal synchronized with the rising timing of the locally-generated signal Lo. However, the timing signal SAMP may be a pulse signal synchronized with the trailing timing, or may be a pulse signal synchronized with both the rising and trailing timing.

### (B) Mixer 33

The mixer 33 is assumed to be a gilbert cell or double balanced mixer. However, any mixer may be used as long as it is a subharmonic mixer.

### (C) Receiving Apparatus

The receiving apparatus is assumed to be a GPS receiving apparatus. However, the invention can be applied similarly to an apparatus which receives a satellite signal in other satellite positioning systems such as a GLONASS (GLObal Navigation Satellite System).

The entire disclosure of Japanese Patent Application No.2009-253733, filed on Nov. 5, 2009 is expressly incorporated by reference herein.

What is claimed is:

1. A frequency converter circuit which multiplies a received signal which is a radio frequency signal by a locally-generated signal and extracts a signal including a frequency corresponding to a difference between the harmonic of the locally-generated signal and the frequency of the radio frequency signal, the frequency converter circuit comprising:
a mixer section that multiplies the received signal by the locally-generated signal;
a timing signal generation section that generates a timing signal synchronized with the locally-generated signal;
a sample-and-hold section that samples and holds an output signal of the mixer section according to the timing signal; and
a filter section that extracts, from an output signal of the sample-and-hold section, a signal component including the frequency corresponding to the difference between the harmonic of the locally-generated signal and the frequency of the radio frequency signal.

2. The frequency converter circuit according to claim 1, wherein
a frequency band to be extracted by the filter section is defined so that the filter section performs the extraction by setting the frequency of the harmonic at a frequency which is N (N≧3) times the frequency of the locally-generated signal.

3. The frequency converter circuit according to claim 1, further comprising:
a locally-generated signal generation section that generates the locally-generated signal as a square wave, wherein
based on the locally-generated signal generated as the square wave and a delay signal obtained by delaying the locally-generated signal, the timing signal generation section generates a pulse signal synchronized with an edge of the locally-generated signal as the timing signal.

4. The frequency converter circuit according to claim 1, wherein
the radio frequency signal has a single frequency which is previously defined, and
the frequency converter circuit is configured as a frequency converter circuit dedicated to the single frequency.

5. The frequency converter circuit according to claim 1, wherein
the radio frequency signal is a satellite signal transmitted by a positioning satellite.

6. A receiving apparatus comprising the frequency converter circuit according to claim 5.
